(19) United States
(12) Patent Application Publication
(10) Pub. No.: US 2026/0017183 A1
(43) Pub. Date: Jan. 15, 2026

(54) CONTROLLER AND STORAGE DEVICE

(71) Applicant: SK hynix Inc., Icheon-si (KR)

(72) Inventors: Do Hyeong LEE, Icheon-si (KR); Hyoung Suk JANG, Icheon-si (KR); Byung Min HA, Icheon-si (KR)

(21) Appl. No.: 19/009,251

(22) Filed: Jan. 3, 2025

(30) Foreign Application Priority Data
Jul. 10, 2024 (KR) 10-2024-0090817

(51) Int. Cl. G06F 12/02

(52) U.S. Cl. CPC G06F 12/023

(57) ABSTRACT

A storage device may manage a location of mapping data for a valid page of a storage block by bit information of a segment bitmap corresponding to a storage block of memory, may load merged segment bitmaps or an unmerged segment bitmap in a single form into a buffer memory, and may search for a valid page depending on the type of data movement operation, so that it is possible to increase the efficiency of searching for valid pages and improve the performance of data movement operations based on searching for valid pages even when the storage capacity of buffer memory is limited.

### CROSS-REFERENCE TO RELATED APPLICATION

The present application claims priority under 35 U.S.C. § 119 (a) to Korean patent application number 10-2024-0090817 filed in the Korean Intellectual Property Office on Jul. 10, 2024, which is incorporated herein by reference in its entirety.

### TECHNICAL FIELD

Embodiments of the present disclosure relate to a controller and a storage device.

### BACKGROUND

A storage device may include a memory including a plurality of memory cells storing data. The storage device may include a controller for controlling the operation of the memory.

The controller may control the operation of the memory according to a command received from an external device or an internal command. For example, the controller may control an operation of writing data to the memory or an operation of reading data written to the memory.

In addition, the controller may control an operation of internally moving data stored in the memory in order to maintain or improve the operation performance of the memory. Efficiently performing the movement operation without affecting the basic operation of the storage device is desirable.

### SUMMARY

Embodiments of the disclosure may provide a method for efficiently performing a data movement operation within the memory of a storage device depending on a type of the storage device or the data movement operation.

Embodiments of the disclosure may provide a storage device including a memory, including a plurality of storage blocks, that stores a plurality of segment bitmaps, each of the plurality of segment bitmaps including bit information indicating a mapping slice that corresponds to at least one of the plurality of storage blocks, the mapping slice including mapping data associated with the corresponding storage block, and a controller configured to generate a merged segment bitmap by loading and merging a first segment bitmap and a second segment bitmap from among the plurality of segment bitmaps into a buffer memory and merging a first segment bitmap and a second segment bitmap, load at least one mapping slice indicated by the merged segment bitmap into the buffer memory, and search for a valid page for a first data movement operation using the at least one mapping slice.

Embodiments of the disclosure may provide a storage device including a memory including a plurality of storage blocks and storing a plurality of segment bitmaps, the plurality of segment bitmaps including bit information that indicates a portion of a mapping table, which includes mapping data indicating an address of a valid page stored in the plurality of storage blocks, and a controller configured to load at least one of the plurality of segment bitmaps into a buffer memory, load the portion of the mapping table indicated by the loaded segment bitmap into the buffer memory, and search for a valid page for a data movement operation using the portion of the mapping table, wherein a total size of a segment bitmap loaded for a first data movement operation is larger than a total size of a segment bitmap loaded for a second data movement operation.

Embodiments of the disclosure may provide a controller including a buffer memory, and a control circuit configured to load a segment bitmap, stored in an external memory including a plurality of storage blocks and corresponding to each of the plurality of storage blocks, into the buffer memory and to search for a valid page by loading at least one mapping slice indicated by the segment bitmap into the buffer memory, wherein a size of a segment bitmap loaded into the buffer memory for a first data movement operation is larger than a size of a segment bitmap loaded into the buffer memory for a second data movement operation.

According to embodiments of the present disclosure, it is possible to easily search for data to be moved within the memory of the storage device and perform the data movement operation depending on a configuration of the storage device or a type of data movement operation, thereby improving the efficiency of the operation of moving data within the memory and enhancing the operation performance of the storage device.

### BRIEF DESCRIPTION OF THE DRAWINGS

FIG. 1 illustrates a schematic configuration of a storage device according to embodiments of the present disclosure.

FIG. 2 illustrates a schematic configuration of a memory and a controller according to embodiments of the present disclosure.

FIG. 3 illustrates an example of a method of managing mapping data associated with a storage block in a storage device according to embodiments of the present disclosure.

FIGS. 4 to 6 illustrate methods for generating a segment bitmap indicating a location of mapping data associated with a storage block in a storage device according to embodiments of the present disclosure.

FIGS. 7 to 10 illustrate methods of searching for a valid page and performing a data movement operation using a segment bitmap in a storage device according to embodiments of the present disclosure.

FIGS. 11 and 12 illustrate another method of searching for a valid page and performing a data movement operation using a segment bitmap in a storage device according to embodiments of the present disclosure.

### DETAILED DESCRIPTION

In the following description of examples or embodiments of the present disclosure, reference will be made to the accompanying drawings in which it is shown by way of illustration specific examples or embodiments that can be implemented, and in which the same reference numerals and signs can be used to designate the same or like components even when they are shown in different accompanying drawings. Further, in the following description of examples or embodiments of the present disclosure, detailed descriptions of well-known functions and components incorporated herein will be omitted when it is determined that the description may make the subject matter in some embodiments of the present disclosure more unclear. The terms such as “including”, “having”, “containing”, “constituting” “made up of”, and “formed of” used herein are generally intended to allow other components to be added unless the terms are used with the term “only”. As used herein, singular forms are intended to include plural forms unless the context clearly indicates otherwise.

Terms, such as “first”, “second”, “A”, “B”, “(A)”, or “(B)” may be used herein to describe elements of the present disclosure. Each of these terms is not used to define essence, order, sequence, or number of elements etc., but is used merely to distinguish the corresponding element from other elements.

When it is mentioned that a first element “is connected or coupled to”, “contacts or overlaps” etc. a second element, it should be interpreted that, not only can the first element “be directly connected or coupled to” or “directly contact or overlap” the second element, but a third element can also be “interposed” between the first and second elements, or the first and second elements can “be connected or coupled to”, “contact or overlap”, etc. each other via a fourth element. Here, the second element may be included in at least one of two or more elements that “are connected or coupled to”, “contact or overlap”, etc. each other.

When time relative terms, such as “after,” “subsequent to,” “next,” “before,” and the like, are used to describe processes or operations of elements or configurations, or flows or steps in operating, processing, or manufacturing methods, these terms may be used to describe non-consecutive or non-sequential processes or operations unless the term “directly” or “immediately” is used together.

In addition, when any dimensions, relative sizes etc. are mentioned, it should be considered that numerical values for elements or features, or corresponding information (e.g., level, range, etc.) include a tolerance range or error margin that may be caused by various factors (e.g., process factors, internal or external impact, noise, etc.) even when a relevant description is not specified. Further, the term “may” fully encompasses all the meanings of the term “can”.

Hereinafter, various embodiments of the present disclosure will be described in detail with reference to accompanying drawings.

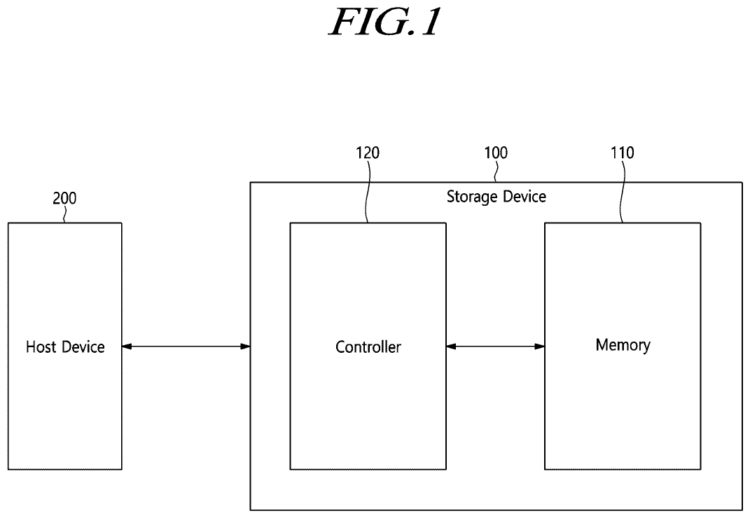

FIG. 1 illustrates a schematic configuration of a storage device according to embodiments of the present disclosure.

Referring to FIG. 1, a storage device 100 may include at least one memory 110. The storage device 100 may include a controller 120 for controlling the operation of the memory 110.

The memory 110 may be, for example, a volatile memory such as DRAM, SDRAM, DDR SDRAM, and LPDDR SDRAM, but the memory 110 according to embodiments of the present disclosure is not limited thereto. The memory 110 may also be a non-volatile memory such as a NAND flash memory, a 3D NAND flash memory, of a NOR flash memory. In addition, some of the memory 110 included in the storage device 100 may be volatile memory, and some may be non-volatile memory.

In addition, the memory 110 may be one of various types of memory, such as a resistive memory (e.g., ReRAM), a phase-change memory, a magnetoresistive memory, a ferroelectric memory, or a spin transfer torque-magnetic memory (e.g., SST-MRAM). In addition, the memory 110 may be a processing-in-memory having an operation function or a data processing function, depending on the application.

The memory 110 may include a plurality of memory cells. Each of the plurality of memory cells may operate as a single-level cell storing one bit of data. Each of the plurality of memory cells may operate as a multi-level cell storing two bits of data. Alternatively, each of the plurality of memory cells may operate as a triple-level cell storing three bits of data or a quad-level cell storing four bits of data. Alternatively, depending on the case, each of the plurality of memory cells may operate as a cell storing five or more bits of data.

In addition, the number of bits of data stored in each of the memory cells may be dynamically determined. For example, a single-level cell storing one bit of data may be changed and operated as a triple-level cell storing three bits of data.

The controller 120 may receive a command from the outside and control the operation of the memory 110 based on the received command. In addition, the controller 120 may control the operation of the memory 110 based on a command generated internally. In this disclosure, a command received from the outside by the controller 120 may be referred to as an external command, and a command generated internally by the controller 120 may be referred to as an internal command.

The controller 120 may control the operation of the memory 110 based on an external command or an internal command. The controller 120 may control, for example, an operation of writing data to the memory 110. The controller 120 may control an operation of reading data written to the memory 110.

The controller 120 may control a data preservation operation (e.g., a refresh operation, a patrol scrub operation, etc.) or an erase operation for data written to the memory 110, depending on the type of the memory 110.

The controller 120 may control the operation of the memory 110 based on a command received from an external host device 200. The controller 120 may provide the host device 200 with a processing result according to an operation corresponding to the command. The controller 120 may transmit data or a response signal to the host device 200.

The host device 200 may be a computer, an ultra-mobile PC (UMPC), a workstation, a personal digital assistant (PDA), a tablet, a mobile phone, a smartphone, an e-book, a portable multimedia player (PMP), a portable game player, a navigation device, a black box, a digital camera, a digital multimedia broadcasting (DMB) player, a smart television, a digital audio recorder, a digital audio player, a digital picture recorder, a digital picture player, a digital video recorder, a digital video player, a storage configuring a data center, one of various electronic devices configuring a home network, one of various electronic devices configuring a computer network, one of various electronic devices configuring a telematics network, an RFID (radio frequency identification) device, and a mobility device (e.g., a vehicle, a robot or a drone) capable of driving under human control or autonomous driving, as non-limiting examples. Alternatively, the host device 200 may be a virtual reality (VR) device providing 2D or 3D virtual reality images or an augmented reality (AR) device providing augmented reality images. In addition to the examples described above, the host device 200 may be any one of various electronic devices that require a storage device 100 capable of storing data.

The host device 200 may include at least one operating system (OS). The operating system may generally manage and control the function and operation of the host device 200, and may control interoperability between the host device 200 and the storage device 100. The operating system may be classified into a general operating system and a mobile operating system depending on the mobility of the host device 200.

The host device 200 and the controller 120 may be separate devices. In some cases, the controller 120 may be implemented as a single device integrated with the host device 200. In this case, the function of the controller 120 may be implemented by being included in the host device 200, and the memory system may include only a memory controller 112 that directly controls the operation of the memory 110. In the following, for the convenience of explanation, examples assume that the controller 120 and the host device 200 are separated from each other.

The controller 120 may perform a background operation related to the memory 110 based on an external command received from the host device 200 or based on an internal command in order to maintain and improve the operation performance of the storage device 100. The background operation may include, for example, one or more of garbage collection, wear leveling, read reclaim, or bad block management operations. The controller 120 may improve the operation performance of the storage device 100 or prevent the operation performance from deteriorating by controlling background operations.

The controller 120 may include various interfaces and processors to process commands from the host device 200 and control the operation of the memory 110. The controller 120 may include at least one working memory providing a data storage space required to perform the operations described above.

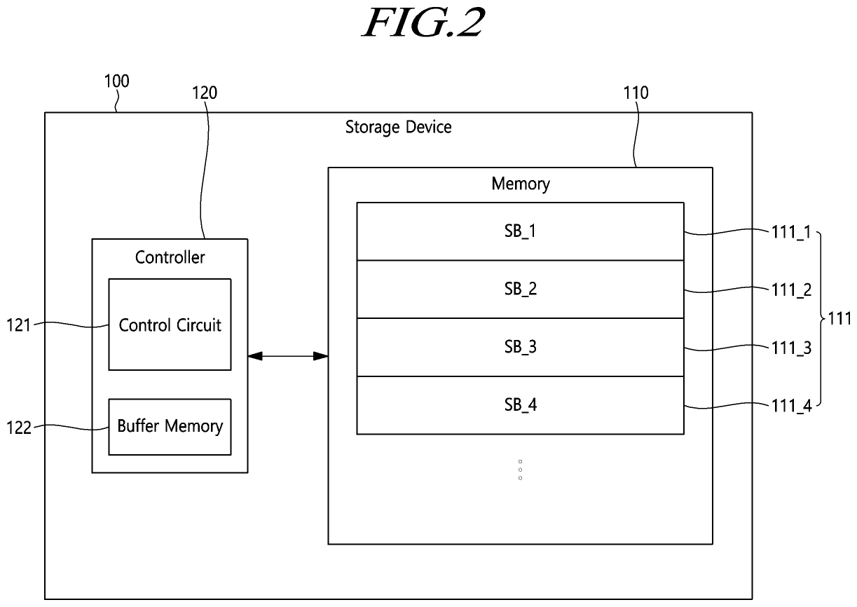

FIG. 2 illustrates a schematic configuration of a memory and a controller according to embodiments of the present disclosure.

Referring to FIG. 2, a memory 110 may include a plurality of storage blocks 111_1, 111_2, 111_3, 111_4, . . . . Each of the plurality of storage blocks 111 may include a plurality of memory cells.

Two or more memory cells included in each of the plurality of storage blocks 111 may constitute a unit storage area. The unit storage area may mean, for example, a page. Two or more memory cells may constitute one page.

Data may be stored in units of a page included in each of the plurality of storage blocks 111. A read operation may be performed on data stored in units of a page in each of the plurality of storage blocks 111. Data stored in each of the plurality of storage blocks 111 may be managed in units of a page.

An erase operation may be performed on data stored in the memory 110. The erase operation may be performed in units different from a write operation or a read operation. For example, the erase operation may be performed in units of a storage block 111. Data write and read operations may be performed in units of a page included in the storage blocks 111, and the erase operation may be performed in units of a storage block 111.

The memory 110 may further include various signal lines for driving memory cells included in the storage blocks 111, a voltage line, and a peripheral circuit for driving signal lines or supplying voltage to the voltage line.

The controller 120 may include an interface for communicating with the host device 200 and an interface for communicating with the memory 110. The controller 120 may include a control circuit 121 for processing a command received from the host device 200 and for controlling the operation of the memory 110.

The control circuit 121 may control the operation of the memory 110 according to a command received from the host device 200. The control circuit 121 may perform a background operation associated with the memory 110 to maintain or improve the operation performance of the memory 110. The control circuit 121 may, for example, perform a background operation during idle time when no commands are processed by the host device 200 to manage the operation performance of the memory 110. In this disclosure, controls performed by the control circuit 121 may also be described as being performed by the controller 120.

The controller 120 may include a buffer memory 122 for storing data required for controlling the operation of the storage device 100. The buffer memory 122 may be, for example, a volatile memory such as SRAM, but the embodiments of the present disclosure are not limited thereto.

The controller 120 may include a plurality of buffer memories 122, and may include a buffer memory 122 with a relatively large capacity such as DRAM. In this case, the DRAM may be a type of working memory and may be located outside the controller 120. The controller 120 and the working memory located outside the controller 120 may be referred to as a control device.

When performing a background operation on the memory 110, the controller 120 may control an operation for moving data within the memory 110. The controller 120 may search for a valid page included in the storage block 111 to check the data to be moved.

The controller 120 may search for a valid page in various ways depending on a type of buffer memory 122 used.

As an example, the controller 120 can utilize various types of tables, which indicate the location of a valid page used for searching for a valid page. The controller 120 may load a table into the buffer memory 122 and search for a valid page using the loaded tables.

For example, the controller 120 may load a valid page table, which indicates the location of a valid page used to search for a valid page, or a mapping table, which indicates a mapping relationship between a logical address (or logical page number) provided by the host device 200 and a physical address (or virtual page number) of the memory 110. The controller 120 may load the mapping table into the buffer memory 122.

The controller 120 may search for the location of a valid page included in the storage block 111 using a table loaded into the buffer memory 122, and may perform a necessary data movement operation.

In order to load a valid page table or a mapping table, a large capacity buffer memory 122 may be required. Embodiments of the present disclosure may provide a method for loading information for searc122hing for a valid page and searching for a valid page when the capacity of the buffer memory 122 is relatively small.

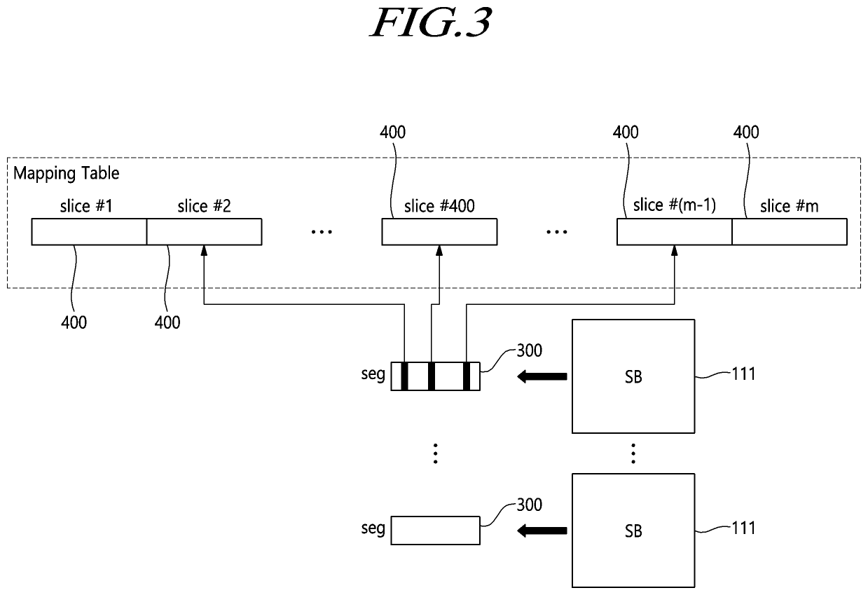

FIG. 3 illustrates an example of a method of managing mapping data associated with a storage block in a storage device according to embodiments of the present disclosure.

Referring to FIG. 3, a controller 120 may store and manage, in a memory 110, a segment bitmap 300 corresponding to each of a plurality of storage blocks 111 included in the memory 110. The segment bitmap 300 may, for example, be stored in an area other than an area where user data is stored in the memory 110. The segment bitmap 300 may be stored in an area where meta data is stored in the memory 110. The segment bitmap 300 may be stored in a memory cell operating as a single-level cell in the memory 110, but embodiments are not limited thereto.

Each segment bitmap 300 may correspond to at least one storage block 111. Examples herein describe a segment bitmap 300 corresponding to one storage block, but in other examples, a segment bitmap 300 may correspond to two or more storage blocks 111.

The segment bitmap 300 may include bit information indicating a portion (or position) of a table that includes location (or address) information of a valid page stored in a corresponding storage block 111.

As an example, if the segment bitmap 300 indicates portions of a mapping table, then the mapping table may include mapping data between a logical address (or logical page number) provided by the host device 200 and a physical address (or virtual page number) of the memory 110. The mapping table may be divided into a plurality of mapping slices 400. As an example, the mapping table may be divided into an m number of mapping slices 400.

The segment bitmap 300 may include bit information indicating a mapping slice 400, which may be a portion of a mapping table including mapping data of a valid page stored in a corresponding storage block 111. The bit information of the segment bitmap 300 may have valid and invalid values. For example, if the bit information of the segment bitmap 300 is a first value (e.g., 1), it may be a valid value, and if the bit information of the segment bitmap 300 is a second value (e.g., 0), it may be an invalid value.

If the bit information of the segment bitmap 300 is a valid value, then a mapping slice 400 indicated by the bit information may include mapping data of a valid page included in a storage block 111 corresponding to the segment bitmap 300. The mapping data of a valid page of a storage block 111 corresponding to the bit information of the segment bitmap 300 may be searched for in unit of a mapping slice 400.

For example, mapping slices 400, such as slice #2, slice #400, and slice #(m−1), may be indicated by bit information having a valid value in a segment bitmap 300 corresponding to a storage block 111. The mapping slices 400, slice #2, slice #400, and slice #(m−1), may include mapping data of valid pages stored in the corresponding storage block 111. The controller 120 may search for mapping slices 400, slice #2, slice #400, and slice #(m−1), to check valid pages stored in the storage block 111.

The controller 120 may load the segment bitmap 300 into a buffer memory 122 and check a mapping slice 400 through the bit information of the segment bitmap 300. The controller 120 may load the checked mapping slice 400 into the buffer memory 122 and search for a valid page.

The controller 120 may load all of the mapping slices, slice #2, slice #400, and slice #(m−1), indicated by the bit information of the segment bitmap 300 into the buffer memory 122 together and search for a valid page, or may sequentially load the mapping slices, slice #2, slice #400, and slice #(m−1), into the buffer memory 122 and search for a valid page.

The capacity of the buffer memory 122 for searching for a valid page may be reduced when a mapping table is loaded into the buffer memory. In disclosed embodiments, however, even if the capacity of the buffer memory 122 is relatively small compared to the size of a mapping table, the controller 120 may search for a valid page stored in the storage block 111 using a segment bitmap 300 and mapping slices 400, and may control a data movement operation for the searched valid page.

When a write operation for each storage block 111 is performed, the controller 120 may, for example, generate and manage a segment bitmap 300 corresponding to each storage block 111.

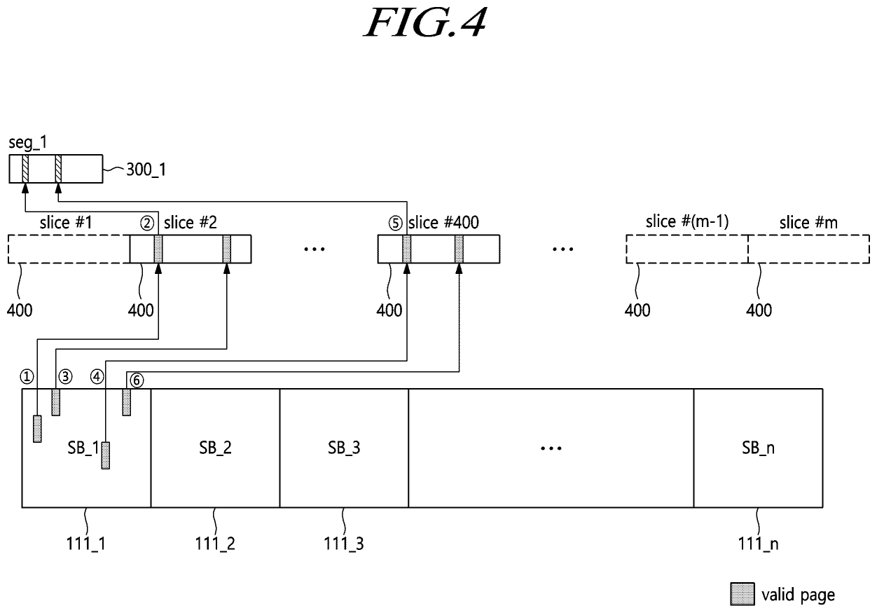

FIGS. 4 to 6 illustrate methods for generating a segment bitmap indicating a location of mapping data associated with a storage block in a storage device according to embodiments of the present disclosure.

In FIG. 4a controller 120 (not illustrated) writes data to a first storage block 111_1 of a memory 110 that includes, for example, an n number of storage blocks 111_1, 111_2, 111_3, . . . , 111_n. The first storage block 111_1 may be in a state in which data is not written to the block. The controller 120 may write data to the first storage block 111_1 according to a command of a host device 200 (not illustrated).

The controller 120 may map a physical address of a storage area (e.g., a page) included in the first storage block 111_1 to a logical address provided by the host device 200, and may write data to a storage area indicated by the mapped physical address.

The controller 120 may write data to the first storage block 111_1, as in \textcircled{1}, and map the address (i.e., location) of a page, to which the data is written, to the logical address provided by the host device 200. The mapping data between a physical address of the page and the logical address from the host device 200 may be located in a mapping slice 400, such as slice #2, for example.

Since the mapping data regarding the data written to the first storage block 111_1 is located in the slice #2, the controller 120 may set bit information indicating, in a first segment bitmap 300_1 corresponding to the first storage block 111_1, that slice #2 of mapping slices 400 has a valid value as in \textcircled{2}. Since the bit information indicating that slice #2 in the first segment bitmap 300_1 is set to a valid value, the controller 120 may confirm, using the first segment bitmap 300_1, that slice #2 of mapping slices 400 includes mapping data indicating a valid page included in the first storage block 111_1.

The controller 120 may write data to the first storage block 111_1 as in \textcircled{3}. The mapping data of the written data may be located in slice #2 of mapping slices 400. Since the bit information of the first segment bitmap 300_1 corresponding to slice #2 is already set to a valid value, the controller 120 may maintain the existing value set in the first segment bitmap 300_1.

The controller 120 may write data to the first storage block 111_1 as in \textcircled{4}. The mapping data of the written data may be located in slice #400 of mapping slices 400.

The controller 120 may set bit information, in the first segment bitmap 300_1, indicating that slice #400 of mapping slices 400 has a valid value as in \textcircled{5}. The controller 120 may confirm that slice #400 of mapping slices 400 includes mapping data indicating the location of a valid page included in the first storage block 111_1 using the first segment bitmap 300_1.

The controller 120 may write data to the first storage block 111_1 as in \textcircled{6}, and the mapping data of the written data may be located in slice #400 of mapping slices 400. The bit information indicating slice #400 in the first segment bitmap 300_1 is already set to a valid value, so the controller 120 may maintain the previously set bit information of the first segment bitmap 300_1 for slice #400.

The controller 120 may store the first segment bitmap 300_1 in the memory 110 when the write operation for the first storage block 111_1 is completed. The first segment bitmap 300_1 may be stored in a memory cell that operates as a single-level cell among the memory cells included in the memory 110. The first segment bitmap 300_1 may be loaded when a search operation for a valid page included in the first storage block 111_1 is performed by the controller 120.

The controller 120 may similarly generate and manage a segment bitmap 300 corresponding to another storage block 111 when a write operation is performed on another storage block 111.

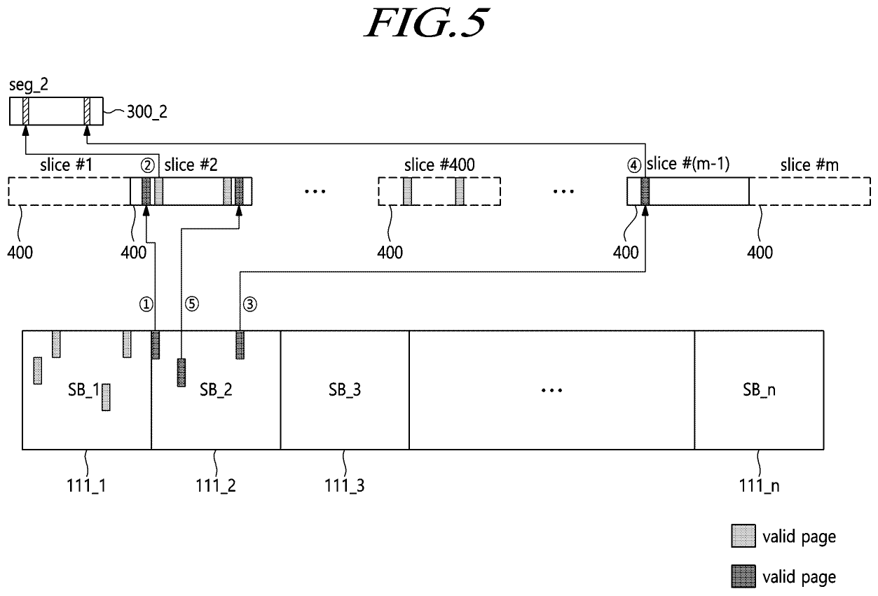

As an example, in FIG. 5, the controller 120 writes data to a second storage block 111_2.

The controller 120 may generate a second segment bitmap 300_2. The controller 120 may write data to the second storage block 111_2 as in \textcircled{1}. The controller 120 may set bit information in a second segment bitmap 300_2 indicating that slice #2 of mapping slices 400 includes mapping data with a valid value for the data written to second storage block 111_2 as in \textcircled{2}. Using the second segment bitmap 300_2, the controller 120 may confirm that slice #2 of mapping slices 400 includes mapping data of a valid page stored in the second storage block 111_2.

The controller 120 may write data to the second storage block 111_2 as in \textcircled{3}. The controller 120 may set bit information of the second segment bitmap 300_2 indicating slice #(m−1) of mapping slices 400 includes mapping data having a valid value for the data written to the second storage block 111_2 as in \textcircled{4}.

The controller 120 may write data to the second storage block 111_2 as in \textcircled{5}. Since the mapping data for the data written to second storage block 111_2 in \textcircled{5} is included in slice #2 of mapping slices 400, the controller 120 may maintain the previously set bit information of the second segment bitmap 300_2.

The controller 120 may store the second segment bitmap 300_2 in the memory 110 when the writing of data to the second storage block 111_2 is complete.

In this way, a segment bitmap 300 corresponding to each storage block 111 may be generated and stored in the memory 110 according to respective writing operations for each storage block 111_1 through 111_n.

After the generation of the segment bitmap 300 is completed, overwriting may be performed on a logical address mapped to a valid page in a storage block 111 corresponding to the generated segment bitmap 300. The overwritten data may be written to a new storage block 111. The controller 120 may update the mapping data according to the overwriting. The bit information of some segment bitmaps 300 may be changed according to the updated mapping data, but the bit information of the segment bitmap 300 which has been generated may be maintained.

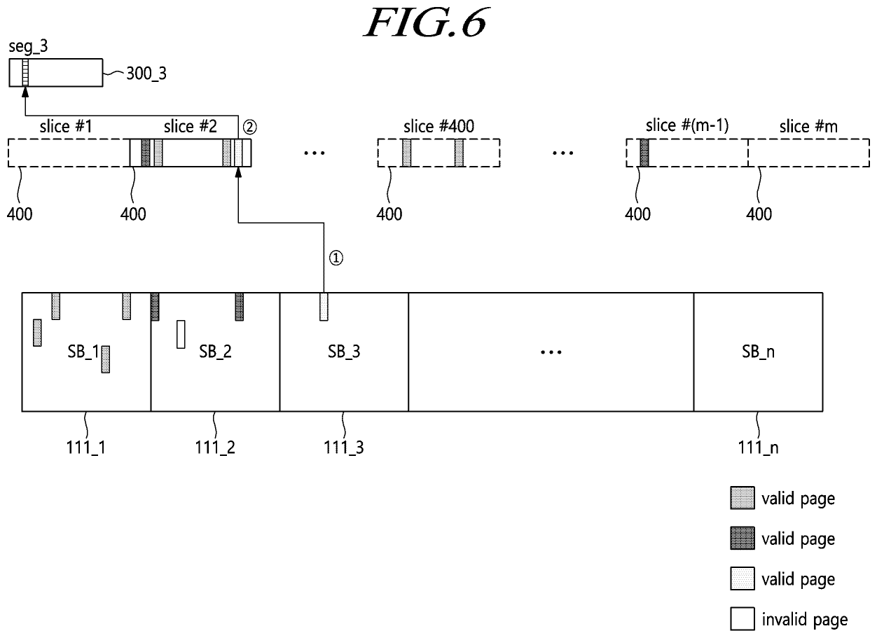

For example, referring to FIG. 6, a write operation may be performed on a third storage block 111_3. The controller 120 may generate a third segment bitmap 300_3.

The controller 120 may write data to the third storage block 111_3. A logical address provided by the host device 200 and associated with the data written to the third storage block 111_3 may be a logical address mapped to the data already written to the second storage block 111_2, as seen in \textcircled{5} of FIG. 5.

When data is written in the third storage block 111_3, the mapping data included in slice #2 of mapping slices 400 may be updated as in \textcircled{1}. Bit information indicating the slice #2 of mapping slices 400 in a third segment bitmap 300_3 may be set to a valid value as in \textcircled{2}.

A page indicated by a previously mapped physical address and a logical address of the overwritten data in the second storage block 111_2 may become an invalid page. Even if the page indicated by the slice #2 of mapping slices 400 in the second storage block 111_2 becomes an invalid page, since the second segment bitmap 300_2 having a valid bit information indicating slice #2 of mapping slices 400 is stored in the memory 110, the bit information of the second segment bitmap 300_2 may not be changed. As a result, a mapping slice 400 associated with an invalid page may remain indicated by the segment bitmap 300.

The controller 120 may store the segment bitmap 300 corresponding to the storage block 111 in the memory 110 when it is generated, and may use the segment bitmap 300 when searching for a valid page stored in each storage block 111.

Since the controller 120 performs searching for a valid page using the segment bitmap 300 and the mapping slices 400, it can search for a valid page even when a buffer memory 122 has a limited capacity.

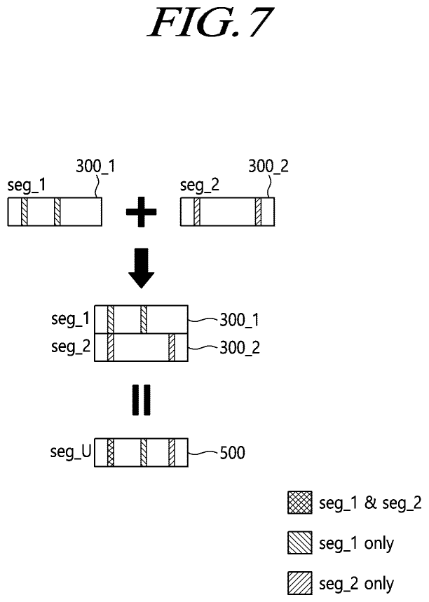

FIGS. 7 to 10 illustrate methods of searching for a valid page and performing a data movement operation using a segment bitmap in a storage device according to embodiments of the present disclosure.

Referring to FIG. 7, when searching for a valid page for the first data movement operation, a controller 120 may merge two or more segment bitmaps 300_1 and 300_2 and perform a search for a valid page.

The first data movement operation may include an operation of moving a valid page from two or more object storage blocks to one target storage block within a memory 110.

The first data movement operation may include an operation of moving data, within the memory 110, from an object storage block storing data in a first memory cell type to a target storage block storing data in a second memory cell type. The first memory cell type may mean a memory cell operating as a single-level cell. The second memory cell type may mean a memory cell other than a memory cell operating as a single-level cell, such as a triple-level cell.

The first data movement operation may be an operation resulting from a command from the controller 120, but in some cases, the first data movement operation may result from a command received from a host device 200.

The controller 120 may load two or more segment bitmaps 300 into a buffer memory 122 for the first data movement operation.

For example, the controller 120 may load the first segment bitmap 300_1 corresponding to the first storage block 111_1 and the second segment bitmap 300_2 corresponding to the second storage block 111_2 into the buffer memory 122.

The controller 120 may merge the first segment bitmap 300_1 and the second segment bitmap 300_2. The controller 120 may generate a merged segment bitmap 500 by merging the first segment bitmap 300_1 and the second segment bitmap 300_2. The merged segment bitmap 500 may be generated by merging the bit information of the first segment bitmap 300_1 and the bit information of the second segment bitmap 300_2.

For example, the controller 120 may set the bit information of the merged segment bitmap 500 corresponding to at least one of the valid bit information of the first segment bitmap 300_1 to a valid value or the valid bit information of the second segment bitmap 300_2 to a valid value. The valid bit information of at least one of the first segment bitmap 300_1 and the second segment bitmap 300_2 may be set to a valid value in the merged segment bitmap 500.

The bit information of the merged segment bitmap 500 may include bit information indicating a mapping slice 400 corresponding only to the first segment bitmap 300_1. The bit information of the merged segment bitmap 500 may include bit information indicating a mapping slice 400 corresponding only to the second segment bitmap 300_2. In addition, in some cases, the bit information of the merged segment bitmap 500 may include bit information indicating a mapping slice 400 corresponding to both the first segment bitmap 300_1 and the second segment bitmap 300_2.

The controller 120 may, in some cases, generate the merged segment bitmap 500 by further merging at least one other segment bitmap 300_n in addition to the first segment bitmap 300_1 and the second segment bitmap 300_2.

The controller 120 may merge the first segment bitmap 300_1 and the second segment bitmap 300_2 if the number of valid pages included in the first storage block 111_1 corresponding to the first segment bitmap 300_1 or the number of valid pages included in the second storage block 111_2 corresponding to the second segment bitmap 300_2 is less than or equal to a preset reference value. Accordingly, it is possible to increase the efficiency of searching for a valid page by merging two or more segment bitmaps 300 corresponding to a storage blocks 111 having a smaller number of valid pages.

The controller 120 may load the mapping slices 400 into the buffer memory 122 using the merged segment bitmap 500, and may search for a valid page for the first data movement operation.

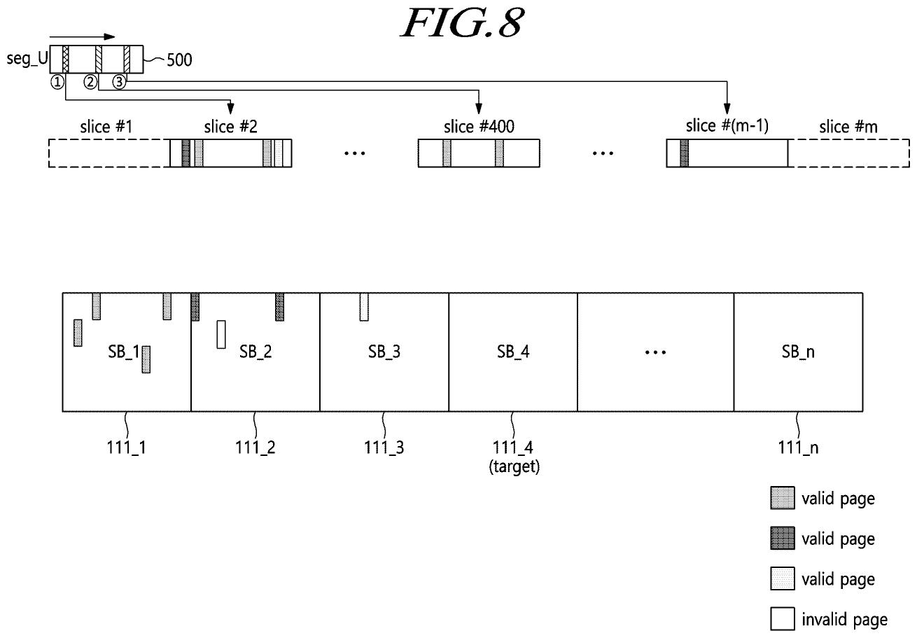

Referring to FIG. 8, a controller 120 may check bit information of the merged segment bitmap 500 loaded into the buffer memory 122. For example, the controller 120 may sequentially check the bit information of the merged segment bitmap 500.

If the bit information of the merged segment bitmap 500 has a valid value, then the controller 120 may load the mapping slices 400 indicated by the bit information into the buffer memory 122. The mapping slices 400 may have a fixed size and may be considered as a part of a mapping table.

The controller 120 may check the valid bit information as in \textcircled{1}, and load slice #2 of mapping slices 400 into the buffer memory 122. The controller 120 may then check the valid bit information, such as \textcircled{2} or \textcircled{3}, and load slice #2 and slice #(m−1) of mapping slices 400 into the buffer memory 122.

Using the merged segment bitmap 500 loaded into the buffer memory 122, the controller 120 may sequentially load the mapping slices 400 indicated by the bit information checked as valid values and may search for valid pages included in the storage block 111.

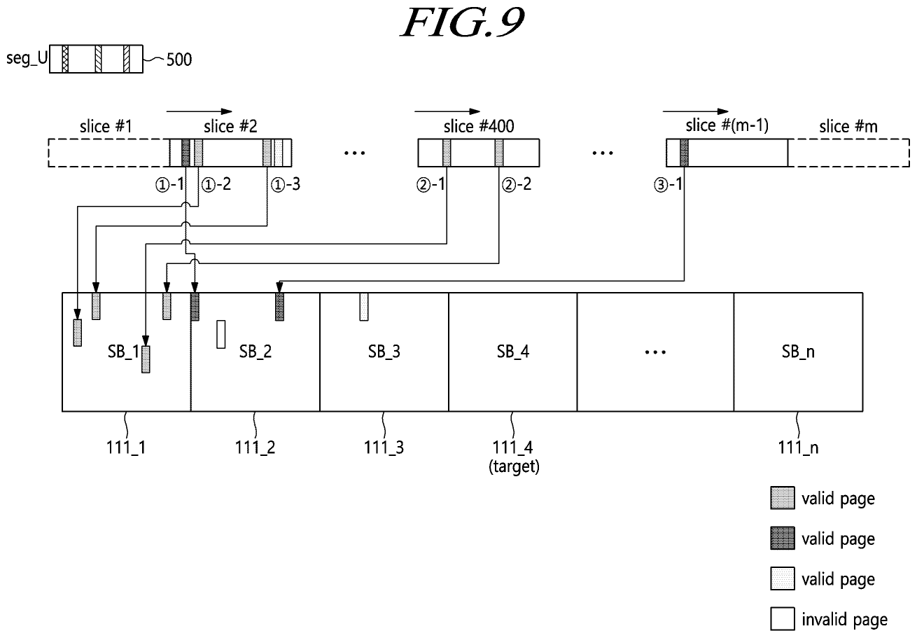

As an example, referring to FIG. 9, the controller 120 may load slice #2 of mapping slices 400 into the buffer memory 122 after checking the merged segment bitmap 500, and may check or verify the mapping data included in slice #2 of mapping slices 400.

The controller 120 may check or verify a valid page included in the second storage block 111_2 as in \textcircled{1}-1 based on the mapping data included in slice #2 of mapping slices 400. The controller 120 may check whether a valid page included in the first storage block 111_1 is \textcircled{1}-2 and \textcircled{1}-3 using the mapping data included in slice #2 of mapping slices 400.

When overwriting occurs after the segment bitmap 300 is generated, the mapping data included in the mapping slices 400 may only include mapping data regarding a valid page included in a current storage block 111, but not include mapping data of the storage block 111 corresponding to the segment bitmap 300.

The mapping slices 400 including invalid mapping data may be indicated by the segment bitmap 300 when searching occurs for a valid page using the mapping slice 400. However, the controller may load mapping slices 400 corresponding to two or more storage blocks 111, as indicated by the bit information included in the segment bitmap 300, to generate a merged segment bitmap 500. Using the merged segment bitmap 500 to search for a valid page improves the efficiency of the search for a valid page.

The controller 120 may sequentially load slice #400 of mapping slices 400 into the buffer memory 122 and may search for a valid page corresponding to the mapping data included in slice #400 of mapping slices 400 as \textcircled{2}-1 and \textcircled{2}-2. Using the mapping data, the valid pages stored in the first storage block 111_1 or the second storage block 111_2 and the physical address (or virtual page number) of the valid page may be checked.

The controller 120 may load slice #(m−1) of mapping slices 400 into the buffer memory 122 and may search for a valid page indicated by the mapping data included in the slice #(m−1) of mapping slices 400 as \textcircled{3}-1.

The controller 120 may check the valid pages stored in the first storage block 111_1 and the second storage block 111_2 using the merged segment bitmap 500. The controller 120 may perform a first data movement operation to move the valid pages stored in the first storage block 111_1 and the second storage block 111_2 to a target storage block.

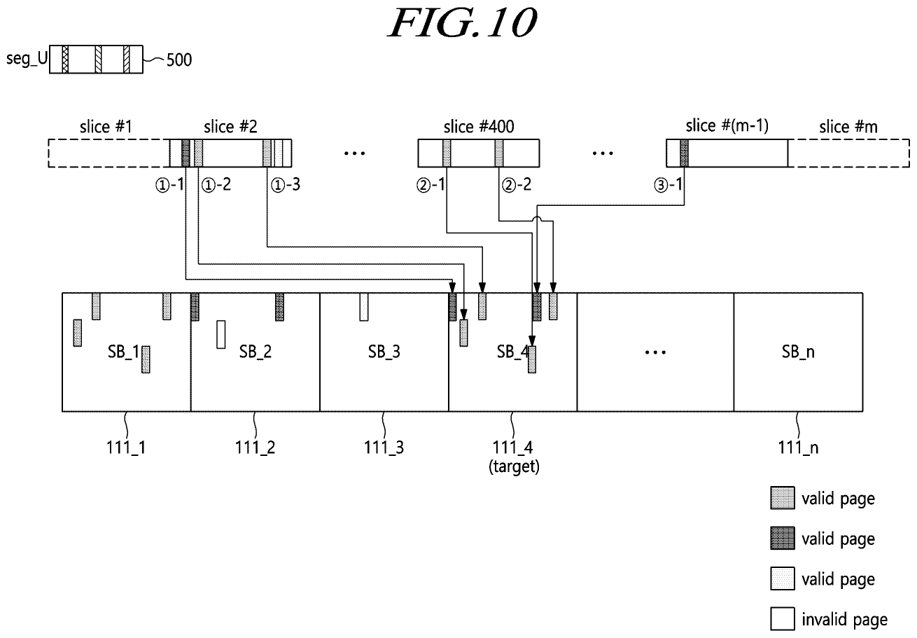

As an example, referring to FIG. 10, a fourth storage block 111_4 may be a target storage block. The first storage block 111_1 and the second storage block 111_2 may be object storage blocks.

The controller 120 may copy a valid page of the first storage block 111_1 and a valid page of the second storage block 111_2, which result from a search using the merges segment bitmap 500, to the fourth storage block 111_4. The valid pages may be stored in the fourth storage block 111_4, and the valid pages of the first storage block 111_1 and the second storage block 111_2 may be changed to invalid pages.

The first data movement operation performed by the controller 120 may be, for example, a garbage collection operation. Through the first data movement operation, the valid pages of the first storage block 111_1 and the second storage block 111_2 may be moved to the fourth storage block 111_4, and the first storage block 111_1 and the second storage block 111_2 may be changed to free storage blocks. The number of free storage blocks may increase as a result of the first data movement operation.

The first data movement operation may be, in another example, an operation of moving a valid page stored in a first memory cell type to the second memory cell type. The first storage block 111_1 and the second storage block 111_2 may be storage blocks 111 that store data in the first memory cell type, and the fourth storage block 111_4 may be a storage block 111 that stores data in the second memory cell type.

The controller 120 may store data according to a write command of the host device 200 in a memory cell that operates as a single-level cell for rapid processing. The controller 120 may move data stored in a memory cell operating as a single-level cell to a memory cell storing data of two or more bits, such as a triple-level cell. Data stored in a single-level cell may be moved to a triple-level cell in the first data movement operation. As a result, the number of free storage blocks operating as single-level cells may increase.

The controller 120 may generate a merged segment bitmap 500 by merging two or more segment bitmaps 300 depending on a type of data movement operation or the number of valid pages stored in the storage block 111, and may search for valid pages based on the merged segment bitmap 500, thereby increasing the search efficiency of valid pages.

In addition, the controller 120 may, in some cases, generate a segment bitmap 300 so that two or more storage blocks 111 correspond to each segment bitmap 300, and may search for valid pages using the segment bitmaps 300 corresponding to two or more storage blocks 111, without performing the merge operation.

For example, a segment bitmap 300 may be generated to correspond to a first storage block 111_1 and a second storage block 111_2. When performing a data movement operation associated with the first storage block 111_1 or the second storage block 111_2, the controller 120 may load the corresponding segment bitmap 300 into the buffer memory 122, and search for a valid page to perform the data movement operation.

In addition, a valid page search using a single segment bitmap 300 may be efficient depending on the type of data movement operation. The controller 120 may determine whether to merge the segment bitmaps 300 based on the type of data movement operation or the number of valid pages stored in the storage block 111, and perform an operation to search for a valid page.

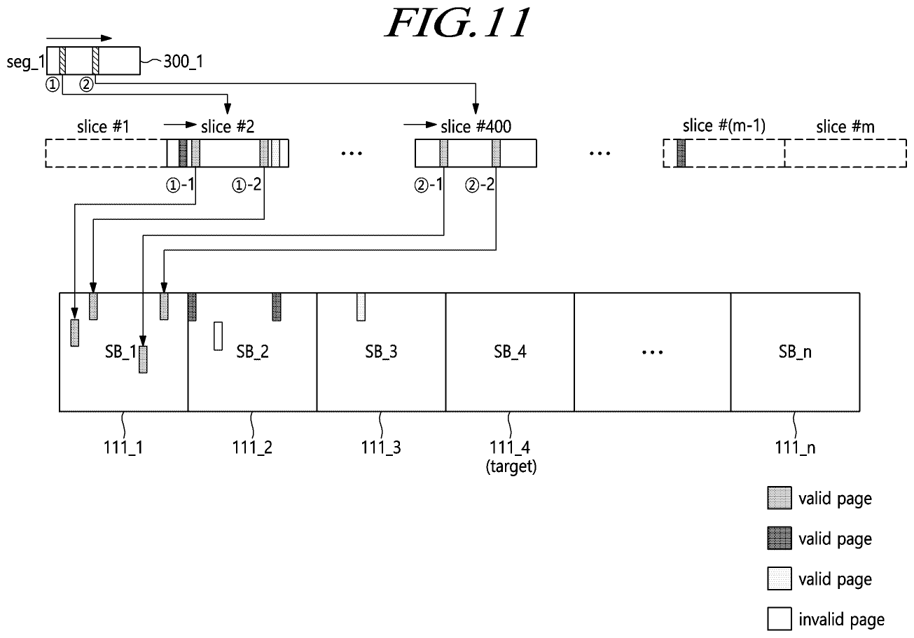

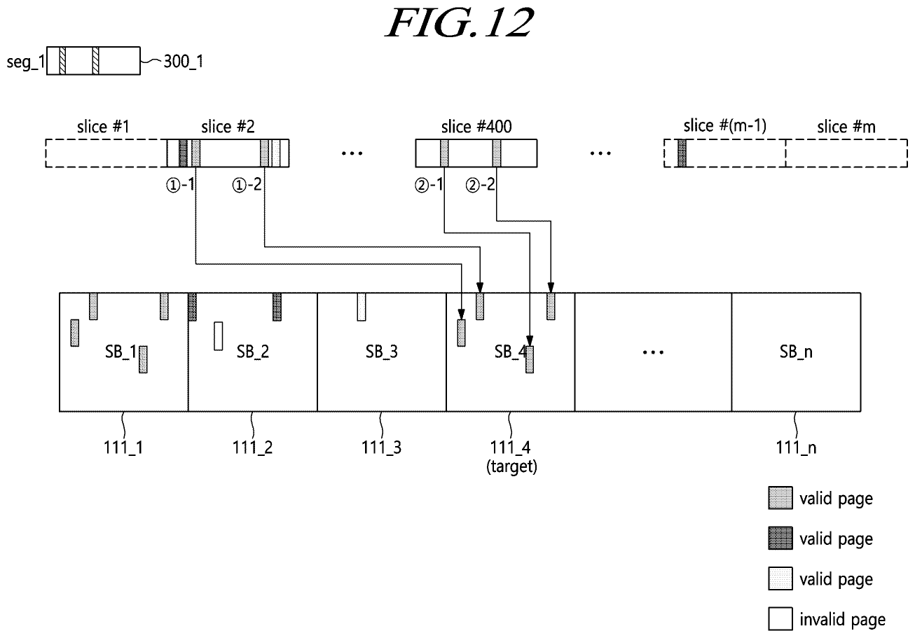

FIGS. 11 and 12 illustrate another method of searching for a valid page and performing a data movement operation using a segment bitmap in a storage device according to embodiments of the present disclosure.

Referring to FIG. 11, a controller 120 may load a segment bitmap 300 into a buffer memory 122 for a second data movement operation.

The second data movement operation may mean an operation of moving a valid page of one object storage block to one target storage block according to a bad block management or a read reclaim operation. Since the controller 120 does not need to merge segment bitmaps 300 in a second data movement operation in which there is one object storage block, the controller 120 may load a single segment bitmap 300 and search for a valid page.

When moving valid pages of two or more object storage blocks to one target storage block, if the number of valid pages stored in each of the two or more target storage blocks is greater than or equal to a preset reference value, then a valid page search may be performed using on a single segment bitmap 300. For a single storage blocks, if the number of valid pages included in each storage block 111 is greater than a specific level, then the search efficiency can be higher when searching for valid pages based on the segment bitmap 300 corresponding to one storage block 111. In this case, a valid page search based on a single segment bitmap 300 may be performed without performing an unnecessary segment bitmap 300 merging operation.

The controller 120 may, as illustrated in FIG. 11, load a first segment bitmap 300_1 into the buffer memory 122 when the first storage block 111_1 corresponds to the object storage block and the fourth storage block 111_4 corresponds to the target storage block.

Only the first segment bitmap 300_1 is loaded into the buffer memory 122, so the total size of the segment bitmap 300 loaded into the buffer memory 122 according to a second data movement operation is less than the total size of the segment bitmap 300 loaded into the buffer memory 122 according to the first data movement operation.

The controller 120 may sequentially check the bit information of the first segment bitmap 300_1. The controller 120 may load the mapping slice 400 indicated by the bit information of the first segment bitmap 300_1 into the buffer memory 122 as in \textcircled{1} and \textcircled{2}.

The controller 120 may load slice #2 of mapping slices 400 indicated by the valid bit information of the first segment bitmap 300_1 into the buffer memory 122, and search for a valid page based on slice #2 of mapping slices 400. The controller 120 may check the valid page of the first storage block 111_1 as in \textcircled{1}-1 and \textcircled{1}-2.

The controller 120 may load slice #400 of mapping slices 400 indicated by the valid bit information of the first segment bitmap 300_1 into the buffer memory 122, and search for a valid page based on slice #400 of mapping slices 400. The controller 120 may check the valid page of the first storage block 111_1 as in \textcircled{2}-1 and \textcircled{2}-2.

The controller 120 may copy the checked valid page to the target storage block.

For example, referring to FIG. 12, the controller 120 may copy a valid page stored in the first storage block 111_1 to the fourth storage block 111_4. The mapping data included in slices #2 and #400 of mapping slices 400 may be changed to indicate a valid page stored in the fourth storage block 111_4. The valid pages of the first storage block 111_1 may be changed to invalid pages.

Since the second data movement operation may be, for example, performed on a one-to-one basis between two storage blocks 111, the number of free storage blocks may be maintained or decreased by the second data movement operation. Alternatively, in some cases, the number of free storage blocks may be increased by the second data movement operation.

In a second data movement operation, the controller 120 may search for a valid page using a single segment bitmap 300 loaded into the buffer memory 122, so that the valid page search may be efficiently performed based on the segment bitmap 300 without performing a merge operation.

According to embodiments of the present disclosure, the controller 120 may merge segment bitmaps 300 or load in unmerged segment bitmaps into a buffer memory 122 and may search for a valid page depending on the type of data movement operation performed by the controller 120, so that it is possible to increase the searching efficiency of a valid page using a segment bitmap 300 and improve the performance of a data movement operation based on a valid page search even when the storage capacity of the buffer memory 122 is limited.

Based on embodiments of the disclosed technology described above, the operation delay time of the memory system may be advantageously reduced or minimized. In addition, according to embodiments of the disclosed technology, an overhead occurring in the process of calling a specific function may be advantageously reduced or minimized. Although various embodiments of the disclosed technology have been described with particular specifics and varying details for illustrative purposes, those skilled in the art will appreciate that various modifications, additions and substitutions may be made based on what is disclosed or illustrated in the present disclosure without departing from the spirit and scope of the invention as defined in the following claims.

What is claimed is:

1. A storage device comprising:
a memory, including a plurality of storage blocks, that stores a plurality of segment bitmaps, each of the plurality of segment bitmaps including bit information indicating a mapping slice that corresponds to at least one of the plurality of storage blocks, the mapping slice including mapping data associated with the corresponding storage block; and
a controller configured to,
generate a merged segment bitmap by loading a first segment bitmap and a second segment bitmap from among the plurality of segment bitmaps into a buffer memory and merging the first segment bitmap and the second segment bitmap,
load at least one mapping slice indicated by the merged segment bitmap into the buffer memory, and
search for a valid page for a first data movement operation using the at least one mapping slice.

2. The storage device of claim 1, wherein the plurality of storage blocks includes two or more object storage blocks and a target storage block, and the controller copies a valid page stored in the two or more object storage blocks from among the plurality of storage blocks to the target storage block in the first data movement operation.

3. The storage device of claim 1, wherein the plurality of storage blocks includes two or more object storage blocks and a target storage block, and
wherein, in the first data movement operation, the controller copies a valid page stored in an object storage block storing data in a first memory cell type to the target storage block storing data in a second memory cell type.

4. The storage device of claim 1, wherein a number of free storage blocks included in the plurality of storage blocks increases after the first data movement operation.

5. The storage device of claim 1, wherein the controller loads one segment bitmap from among the plurality of segment bitmaps into the buffer memory, loads at least one mapping slice indicated by the one segment bitmap into the buffer memory, and searches for a valid page for a second data movement operation using the at least one mapping slice.

6. The storage device of claim 5, wherein the plurality of storage blocks includes two or more object storage blocks and a target storage block, and
wherein the controller copies a valid page stored in one object storage block to the target storage block according to the second data movement operation.

7. The storage device of claim 5, wherein the controller copies a valid page stored in an object storage block to a target storage block according to the first data movement operation or the second data movement operation,
wherein a number of bits stored in a memory cell included in the target storage block is greater than or equal to a number of bits stored in a memory cell included in the object storage block.

8. The storage device of claim 5, wherein a total size of the segment bitmaps loaded into the buffer memory before loading the at least one mapping slice into the buffer memory for the first data movement operation is larger than a total size of the segment bitmap loaded into the buffer memory before loading the at least one mapping slice into the buffer memory for the second data movement operation.

9. The storage device of claim 1, wherein the controller sets bit information of the merged segment bitmap corresponding to bit information having a valid value, in at least one of the first segment bitmap or the second segment bitmap, to a valid value and generates the merged segment bitmap.

10. The storage device of claim 1, wherein the controller generates the merged segment bitmap if at least one of a number of valid pages included in the storage block corresponding to the first segment bitmap or a number of valid pages included in the storage block corresponding to the second segment bitmap is less than or equal to a preset reference value.

11. The storage device of claim 1, wherein at least one of the mapping data included in the at least one mapping slice indicates a virtual page number included in a storage block other than a storage block corresponding to the first segment bitmap and a storage block corresponding to the second segment bitmap.

12. The storage device of claim 1, wherein the plurality of segment bitmaps are stored in a storage block, from among the plurality of storage blocks, that stores data in a single-level cell type.

13. A storage device comprising:
a memory including a plurality of storage blocks and storing a plurality of segment bitmaps, the plurality of segment bitmaps including bit information that indicates a portion of a mapping table, which includes mapping data indicating an address of a valid page stored in the plurality of storage blocks; and
a controller configured to,
load at least one of the plurality of segment bitmaps into a buffer memory,
load the portion of the mapping table indicated by the loaded segment bitmap into the buffer memory, and
search for a valid page for a data movement operation using the portion of the mapping table,
wherein a total size of a segment bitmap loaded for a first data movement operation is larger than a total size of a segment bitmap loaded for a second data movement operation.

14. The storage device of claim 13, wherein the plurality of storage blocks includes two or more object storage blocks and a target storage block, and
wherein the controller copies a valid page included in two or more first object storage blocks to a first target storage block according to the first data movement operation, and copies a valid page included in another object storage block among the plurality of storage blocks to a second target storage block according to the second data movement operation.

15. The storage device of claim 13, wherein the plurality of storage blocks includes two or more object storage blocks and a target storage block,
wherein the controller copies, according to the first data movement operation, a valid page stored in an object storage block storing data in a first memory cell type to a target storage block storing data in a second memory cell type, and
wherein the controller copies, according to the second data movement operation, a valid page stored in an object storage block storing data in the first memory cell type to a target storage block storing data in the first memory cell type, or copies a valid page stored in an object storage block storing data in the second memory cell type to a target storage block storing data in the second memory cell type.

16. The storage device of claim 13, wherein a number of free storage blocks included in the plurality of storage blocks increases by the first data movement operation, and the number of free storage blocks included in the plurality of storage blocks is maintained or decreased by the second data movement operation.

17. A controller comprising:
a buffer memory; and
a control circuit configured to load a segment bitmap, stored in an external memory including a plurality of storage blocks and corresponding to each of the plurality of storage blocks, into the buffer memory and to search for a valid page by loading at least one mapping slice indicated by the segment bitmap into the buffer memory,
wherein a size of a segment bitmap loaded into the buffer memory for a first data movement operation is larger than a size of a segment bitmap loaded into the buffer memory for a second data movement operation.

18. The controller of claim 17, wherein the control circuit loads a first segment bitmap and a second segment bitmap into the buffer memory for the first data movement operation and merges the first segment bitmap and the second segment bitmap to generate a merged segment bitmap.

19. The controller of claim 18, wherein at least one of a number of valid pages included in a storage block corresponding to the first segment bitmap or a number of valid pages included in a storage block corresponding to the second segment bitmap is less than or equal to a preset reference value.

20. The controller of claim 18, wherein a memory cell included in a storage block corresponding to the first segment bitmap and a storage block corresponding to the second segment bitmap stores data in a single-level cell type.
